(19) United States
(12) Patent Application Publication
(10) Pub. No.: US 2003/0085342 A1
(43) Pub. Date: May 8, 2003

(54) Light sensitive signaling device

(76) Inventor: Ben Zehavi, Sherman Oaks, CA (US)

Correspondence Address: CHARLES R. SUTTON, 14507 SYLVAN ST., STE. 208, VAN NUYS, CA, 91411, US

(21) Appl. No.: 09/993,457

(22) Filed: Nov. 6, 2001

(51) Int. Cl. H01J 40/14

(52) U.S. Cl. 250/215

(57) ABSTRACT

A device which can detect changes in the light intensity of its location and provide messages in response to these changes. The messages could be in the form of auditory cues such as the replay of a recorded voice message containing a reminder, salutation or reaffirmation. The messages could be in the form of wireless messages sent to the personal digital assistant of the user. In one embodiment the device would be equipped with a timer so that it can give its messages in response to the day, or hour, or the amount of time elapsed since a change in the room's lighting condition.

### CROSS-REFERENCES TO RELATED APPLICATIONS

There are no related applications.

### STATEMENT AS TO RIGHTS TO INVENTIONS MADE UNDER FEDERALLY-SPONSORED RESEARCH AND DEVELOPMENT

This invention was not made under Federally Sponsored Research and Development.

### BACKGROUND OF THE INVENTION

1. Field of the Invention

This invention falls within the field of photosensitive devices which control other devices, possibly with the additional input of a timer, voice chip, recorder, and signaling device.

2. Description of Related Art Including Information Disclosed Under 37 CFR Sections 1.97 and 1.98

Typical devices in the field include devices which dim an automobile's headlights in response to an oncoming car's headlights. Other devices exist which will turn on the lights in the garage when a car drives up to the house at night with its headlights on. Often the devices come equipped with a timer or a motion detector. Devices with a timer are often used to turn on something such as lawn sprinklers a certain length of time after dawn or dusk. Devices with motion detectors are typically used to turn on the room lights when a person enters the room.

### SUMMARY OF THE INVENTION

This invention is a device which can sense changes in the amount of light in a room, and possibly sense the passage of time, for the purpose of signaling when specified conditions arise. A typical use would be that the device plays a recorded voice reminder when the lights are turned on in the morning or when the lights are turned off in the evening. The device could also, but not necessarily, send a wireless message to a personal digital assistant, for example, when specified conditions arise where the device is able to sense them, such as four hours after the lights were turned on in the morning a reminder message could be sent to mail payment of a bill.

### BRIEF DESCRIPTION OF THE DRAWINGS

FIG. 1 shows the invention in an embodiment featuring a volume control knob and an input jack.

FIG. 2 shows the invention in an embodiment having speaker volume controlled by a cover.

FIG. 3 shows the embodiment of FIG. 2 as it would appear with the cover slid over the speaker.

FIG. 4 shows the invention in an embodiment having an alarm.

FIG. 5 is a side view of the alarm type embodiment of the invention.

FIG. 6 is a flow chart showing how the various subunits of the invention interact.

### DESCRIPTION OF THE PREFERRED EMBODIMENT

The preferred embodiment of this invention involves a light sensitive messaging machine which would hold recorded messages for future replay, replay those messages at a pre-programmed time and/or immediately after a specific event, send wireless messages to a remote personal digital assistant, display time and date, plug into an AC wall jack and have a way to control the amplitude of the signal. The recorded messages could either be provided by the factory or the device could have a microphone allowing the user to prepare his or her own messages.

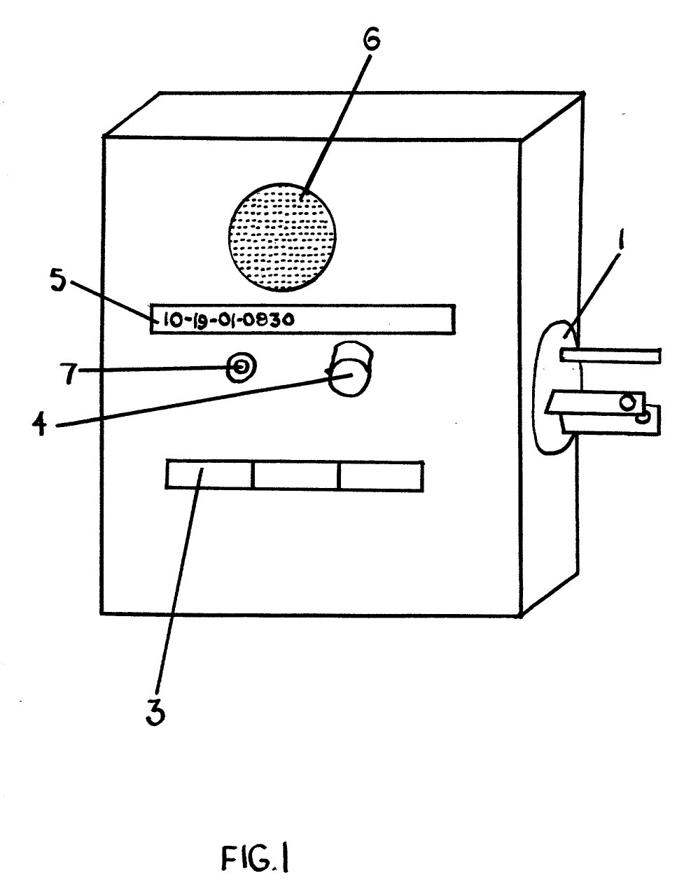

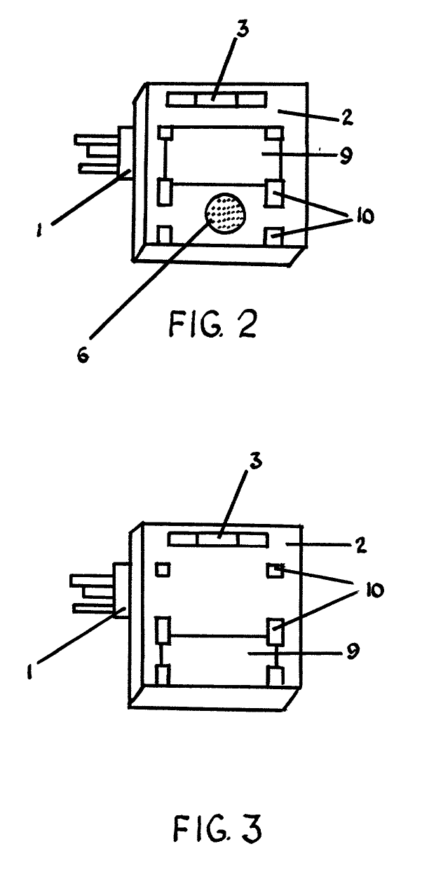

Referring now to FIG. 1, the invention is shown with a power plug (1) which is attached to the chassis (2) of the invention. On the face of the chassis is a photosensitive cell (3), a volume control knob (4), a display (5), a speaker (6), and a jack (7) for the input of information to the device. FIG. 2 and FIG. 3 show how the invention could have a less expensive means to control the volume in the form of a mechanical cover (9) which can slide over the speaker (6). The cover may be held on by retaining stops (10) which form a framework within which the cover slides. The cover is slid away from the speaker as in FIG. 2 to control the volume. The cover is slid over the speaker as in FIG. 3 to the device's volume.

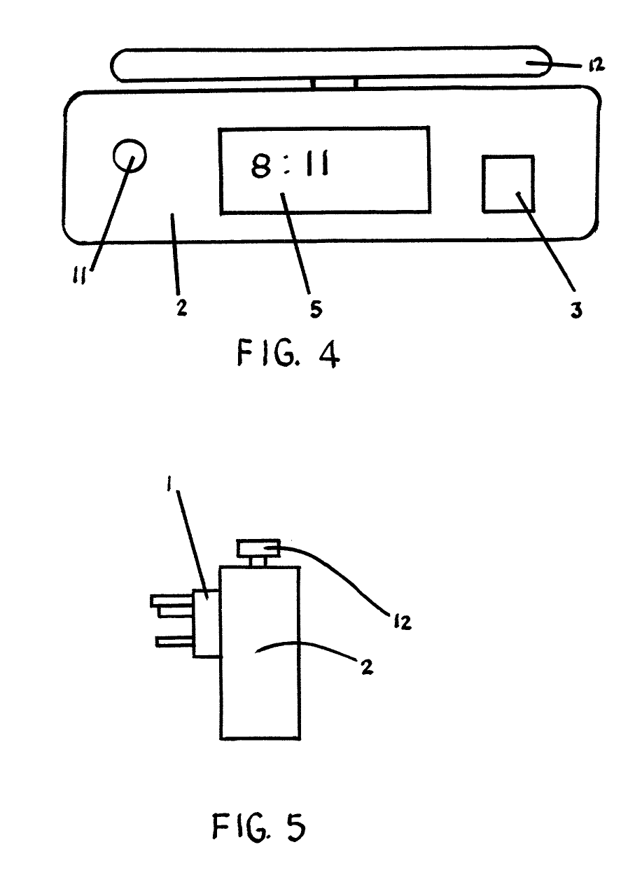

The invention has many features in common with an alarm clock, except that it is equipped to provide its messages at nonspecific times determined by when the lights are turned lower or higher in a room. FIG. 4 shows how the device could be equipped with a switch (11) by which the alarm can be activated. The device also can be equipped with a shutoff (12) by which the alarm or message can be deactivated. The device can provide a warning if the alarm has not been set at night, but if it senses the alarm has been set, it would not provide the warning. In this case it will either do nothing in response to that stimulus or it may simply give another message, such as to tell the user “goodnight.” The difference from an ordinary alarm clock is that the invention can sense light in the morning, wait ten minutes and then provide a voice reminder to go to the post office today, for example. FIG. 5 shows a side view of the invention including its power plug.

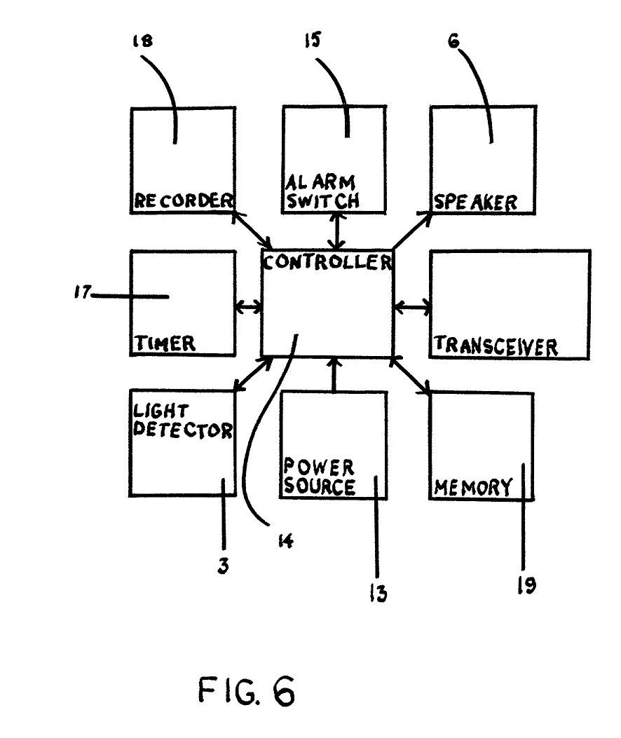

FIG. 6 shows a flow chart of how the various subunits of the invention work together to produce the desired effect. A power source (13) provides electricity to a controller (14). The controller, in turn provides power to the various devices described below and in FIG. 6 as needed. There is an alarm switch (15) which can control the controller or be controlled by it depending on the programming. The controller operates a transceiver (16) and a speaker (6). Both the speaker and the transceiver are receiving electricity from the power source through the controller as well as instructions from the controller. The device has a photosensitive cell (3) which provides information to the controller and may receive electricity from the controller. A timer (17) receives electricity and instructions from the controller and provides information to the controller. A recorder (18) receives electricity and instructions from the controller and shares information with a memory (19) via the controller. The memory sends information to the controller and receives electricity and information from the controller. The controller uses the programming information from the memory to control the speaker, timer or the transceiver. The controller can send messages stored in the memory through the speaker or transceiver. The programming would tell the controller which conditions of light intensity or passage of time or switching condition of the alarm switch would prompt which stored message to send and how and when to send it. The invention can be adapted so that signaling is caused by passage of time and not necessarily dependent on light intensity. Because of the timer, the wireless signal could be sent a specified length of time before and/or after an event and/or simply sent at the time of the event. The invention could measure time from the last time the alarm was set or the last time it was deactivated and send a signal after a specified length of time. For example, the invention could send a wireless reminder twenty two hours after the last time the alarm feature had been set on the device. The wireless reminder could be received by another device carried by a specified individual such as a pager, a personal digital assistant, a laptop computer, cellular telephone, etc. The transceiver could be capable of sending messages over ordinary land lines such as cable or the telephone system.

I claim:

1. A signaling apparatus comprising a photosensitive means, a controller, and a signaling means; said controller being responsive to variations in light intensity as communicated to it by said photosensitive means; said controller having a memory capable of storing data; said controller using data from said memory to actuate said signaling means in response to specified conditions of light intensity.

2. The signaling apparatus of claim 1 having a means to control the amplitude of the signaling means.

3. The signaling apparatus of claim 1 having a means for quantifying luminosity, said controller using data from said memory to actuate said signaling means only in response to sensation of specified quantities of lumens.

4. The signaling apparatus of claim 1 having a means for placing data into said memory.

5. The signaling apparatus of claim 1 further comprising a transceiver capable of sending and receiving a signal through telecommunication lines.

6. The signaling apparatus of claim 1 wherein said signaling means is a transceiver capable of sending and receiving a wireless signal.

7. The signaling apparatus of claim 1 further comprising a timing means; said controller being responsive to variations in time as communicated to it by said timing means; said controller using data from said memory to actuate said signaling means in response to specified conditions of time.

8. A signaling apparatus comprising a photosensitive means, a timing means, a controller, and a signaling means; said controller being responsive to variations in light intensity as communicated to it by said photosensitive means; said controller being responsive to variations in time as communicated to it by said timing means; said controller having a memory capable of storing data; said controller using data from said memory to actuate said signaling means in response to specified conditions of light intensity.

9. The signaling apparatus of claim 8 having a means to control the amplitude of said signaling means.

10. The signaling apparatus of claim 8 having a means for quantifying luminosity, said controller using data from said memory to actuate said signaling means only in response to sensation of specified quantities of lumens.

11. The signaling apparatus of claim 8 having a means for placing data into said memory.

12. The signaling apparatus of claim 8 further comprising said controller using data from said memory to actuate said signaling means in response to specified conditions of time.

13. The signaling apparatus of claim 8 wherein said signaling means is a transmitter capable of sending a wireless signal.

14. The signaling apparatus of claim 8 further comprising a transceiver capable of sending and receiving a signal through telecommunication lines.

15. A remote signaling apparatus comprising a timing means, a controller, and a wireless transmission means; said controller being responsive to variations in time as communicated to it by said timing means; said controller having a memory capable of storing data; said controller using data from said memory to actuate said wireless transmission means in response to specified conditions of time; said wireless transmission means sending a signal defined by data from said memory; said signal being receivable by a specified electronic device carried by the person being signaled.

16. The remote signaling apparatus of claim 14 having a means to specify said specified electronic device.

17. The remote signaling apparatus of claim 14 having a means for displaying the data from said memory.

18. The remote signaling apparatus of claim 14 having a means for placing data into said memory.

19. The remote signaling apparatus of claim 14 further comprising a photosensitive means; said controller being responsive to variations in light intensity as communicated to it by said photosensitive means; said controller using data from said memory to actuate said signaling means in response to specified conditions of light intensity.

20. The remote signaling apparatus of claim 14 having a speaker and said controller can send auditory signals from said speaker; said auditory signals being defined by data from said memory.
